(19) United States
(12) Patent Application Publication
(10) Pub. No.: US 2020/0398827 A1
(43) Pub. Date: Dec. 24, 2020

(54) PARKING ASSIST SYSTEM

(71) Applicant: HONDA MOTOR CO., LTD., Tokyo (JP)

(72) Inventor: Yuki HARA, Saitama (JP)

(21) Appl. No.: 16/907,620

(22) Filed: Jun. 22, 2020

(30) Foreign Application Priority Data
Jun. 24, 2019 (JP) 2019-116688

(51) Int. Cl. B60W 30/06; B62D 15/02; G08G 1/16; B60W 50/14

(52) U.S. Cl. CPC B60W 30/06; B62D 15/0285; B60W 2050/146; B60W 50/14; G08G 1/168

(57) ABSTRACT

A parking assist system includes a control device configured to control a vehicle so as to move the vehicle autonomously from a current position to a target position; a vehicle position detecting device configured to detect a position of the vehicle; a first operation detecting device configured to detect an operation; a second operation detecting device configured to detect an operation; and an output device configured to make a notification. When the position of the vehicle detected by the vehicle position detecting device is within a prescribed range from the target position and the second operation detecting device detects any of an operation by a driver included in a second operation group, the control device stops the vehicle and ends control of the vehicle to the target position without making the output device notify that the control of the vehicle to the target position is canceled.

### TECHNICAL FIELD

The present invention relates to a parking assist system that moves a vehicle autonomously from a current position to a target position.

### BACKGROUND ART

JP2019-43174A discloses a parking assist system that stops a vehicle to shift to a standby mode, makes a notification device notify the next executable operation, and makes a driver select a next operation in a case where a prescribed cancellation condition is satisfied while executing automatic parking assistance.

However, in the parking assist system disclosed in JP2019-43174A, the driver needs to perform an operation for selecting the next operation regardless of the state of the vehicle when the automatic parking assistance is canceled.

### SUMMARY OF THE INVENTION

In view of such a problem of the prior art, a primary object of the present invention is to provide a parking assist system that can control the movement of the vehicle according to the driver's intention and thereby improve the convenience of the driver in a case where a prescribed condition is satisfied and the vehicle is stopped during the automatic parking assistance.

To achieve such an object, one embodiment of the present invention provides a parking assist system (1), including: a control device (15) configured to control a vehicle including a powertrain (4), a brake device (5), and a steering device (6) so as to move the vehicle autonomously from a current position to a target position; a vehicle position detecting device (7, 10) configured to detect a position of the vehicle with respect to the target position; a first operation detecting device (12, 29, 30, 34) configured to detect an operation by a driver included in a first operation group; a second operation detecting device (27, 52, 53) configured to detect an operation by the driver included in a second operation group and related to a stop of the vehicle; and an output device (32, 33) configured to make a notification to an occupant based on an instruction from the control device, wherein during control of the vehicle to the target position, when the first operation detecting device detects any of the operation by the driver included in the first operation group, the control device makes the output device notify that the control of the vehicle to the target position is canceled, stops the vehicle, and cancels a movement of the vehicle to the target position, and when the position of the vehicle detected by the vehicle position detecting device is within a prescribed range from the target position and the second operation detecting device detects any of the operation by the driver included in the second operation group, the control device stops the vehicle and ends the control of the vehicle to the target position without making the output device notify that the control of the vehicle to the target position is canceled.

In a case where the driver performs the operation included in the second operation group (for example, a brake operation) that is related to a stop of the vehicle when the position of the vehicle is within the prescribed range from the target position, it can be estimated that the driver thinks that the vehicle has reached the target position and thereby performs the operation included in the second operation group. According to the above arrangement, in such a case, the control device ends the control of the vehicle to the target position (hereinafter referred to as “movement control”) without making the output device notify that the movement control is canceled. That is, in such a case, the movement control ends by the same process as in a case where the vehicle has reached the target position and thereby the movement control normally ends. Therefore, the driver is not bothered by a warning sound by the output device, an operation for selecting a process after the movement of the vehicle is stopped, and the like, so that the convenience of the driver can be improved.

Preferably, the first operation group includes the operation included in the second operation group.

According to this arrangement, the vehicle can be stopped in a case where the driver performs the operation included in the second operation group. Incidentally, in a case where the position of the vehicle is not within the prescribed range from the target position, it cannot be estimated that the driver intends to park the vehicle at the present position even if the driver performs the operation included in the second operation group. In such a case, the control device can make the output device notify that the movement control is canceled.

Preferably, the vehicle further includes: a brake input member (24) configured to receive an operation for driving the brake device; a parking brake input member (51) configured to receive an operation for driving a parking brake device (5a); and a shift member (25) configured to receive an operation for switching a shift position, and the second operation group includes the operation of the brake input member, the operation of the parking brake input member, and the operation of the shift member for switching the shift position to a parking position.

In a case where the operation of the brake input member, the operation of the parking brake input member, or the operation of the shift member for switching the shift position to the parking position is detected, it can be estimated that the driver intends to stop the movement of the vehicle. According to the above arrangement, it is possible to stop the vehicle and end the movement control according to such a driver's intention.

Preferably, the vehicle further includes a switch (34) for switching a control state of an autonomous movement of the vehicle, and the first operation group includes an operation for driving the steering device or the brake device, the operation of the switch, and an operation by the occupant related to alighting from the vehicle.

Preferably, the second operation group does not include the operation for driving the steering device, the operation of the switch, and the operation by the occupant related to alighting from the vehicle.

Preferably, the second operation group includes the operation for driving the brake device.

In a case where the driver performs the operation for driving the steering device, it can be estimated that the driver intends to change the trajectory calculated by the control device and that the driver does not think that the vehicle has reached the target position. According to the above arrangements, when the driver performs the operation for driving the steering device, the control device ends the movement control (automatic parking assistance) without estimating that the driver thinks that the vehicle has reached the target position. Accordingly, it is possible to control the movement of the vehicle according to the driver's intention, so that the convenience of the driver can be improved. Also, in a case where the driver performs the operation for driving the brake device even though the vehicle is far from the target position, it can be estimated that the driver finds an obstacle or the like and intends to stop the movement of the vehicle. According to the above arrangements, in such a case, the notification that the movement control is canceled is made, so that the convenience of the driver is improved. Also, in a case where the driver operates the switch for switching the control state of the autonomous movement of the vehicle, it can be estimated that the driver intends to end the movement control (automatic parking assistance) and that the driver does not think that the vehicle has reached the target position. According to the above arrangements, when the driver operates the switch, the control device ends the movement control (automatic parking assistance) without estimating that the driver thinks that the vehicle has reached the target position. Accordingly, it is possible to control the movement of the vehicle according to the driver's intention, so that the convenience of the driver can be improved. Also, according to the above arrangements, in a case where the occupant tries to alight from the vehicle during the movement control, the movement of the vehicle is stopped and the notification that the movement control is canceled is made, so that the safety of the occupant and the convenience of the driver are improved.

Preferably, during the control of the vehicle to the target position, in a case where the operation for driving the steering device is detected and thereby the movement of the vehicle to the target position is canceled, the control device sets the vehicle to a state in which the vehicle is moved according to driving by the driver.

In a case where the driver performs the operation for driving the steering device, it can be estimated that the driver intends to change the trajectory calculated by the control device and shift to a manual driving state and that the driver does not think that the vehicle has reached the target position. According to the above arrangement, when the driver performs the operation for driving the steering device, the control device sets the vehicle to a state in which the vehicle is moved according to driving by the driver (namely, the control device sets the vehicle to the manual driving state) and ends the movement control (automatic parking assistance). Therefore, it is possible to control the movement of the vehicle according to the driver's intention, so that the convenience of the driver can be improved.

Preferably, during the control of the vehicle to the target position, when the first operation detecting device detects any of the operation by the driver included in the first operation group, on condition that the position of the vehicle detected by the vehicle position detecting device is not within the prescribed range from the target position or the second operation detecting device does not detect any of the operation by the driver included in the second operation group, the control device makes the output device notify that the control of the vehicle to the target position is canceled, stops the vehicle, and cancels the movement of the vehicle to the target position.

Thus, according to one embodiment of the present invention, it is possible to provide a parking assist system that can control the movement of the vehicle according to the driver's intention and thereby improve the convenience of the driver in a case where a prescribed condition is satisfied and the vehicle is stopped during the automatic parking assistance.

### BRIEF DESCRIPTION OF THE DRAWINGS

FIG. 1 is a functional block diagram of a vehicle provided with a parking assist system according to an embodiment of the present invention;

FIG. 2 is a flow chart of an automatic parking process in the parking assist system according to the embodiment;

FIG. 3A is a diagram showing a screen display of a touch panel during a target parking position reception process in the parking assist system according to the embodiment;

FIG. 3B is a diagram showing the screen display of the touch panel during a driving process in the parking assist system according to the embodiment;

FIG. 3C is a diagram showing the screen display of the touch panel when automatic parking is completed in the parking assist system according to the embodiment; and

FIG. 4 is a flow chart showing details of a driving process and a parking process in the parking assist system according to the embodiment.

### DESCRIPTION OF THE PREFERRED EMBODIMENT(S)

In the following, an embodiment of the present invention will be described in detail with reference to the drawings.

A parking assist system 1 is mounted on a vehicle such as an automobile provided with a vehicle control system 2 configured to make the vehicle travel autonomously.

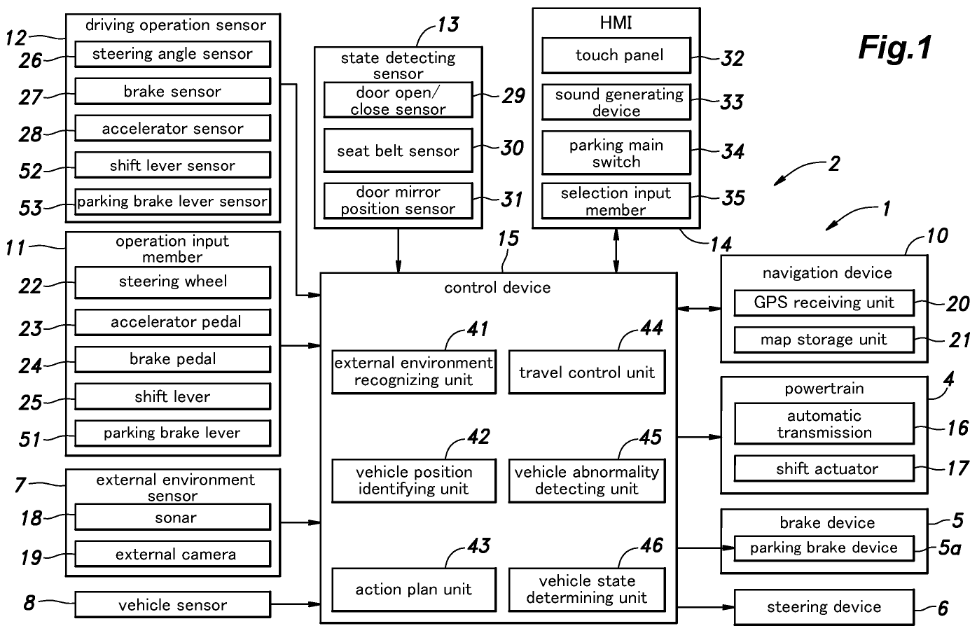

As shown in FIG. 1, the vehicle control system 2 includes a powertrain 4, a brake device 5, a steering device 6, an external environment sensor 7, a vehicle sensor 8, a navigation device 10, an operation input member 11, a driving operation sensor 12, a state detecting sensor 13, a human machine interface (HMI) 14, and a control device 15. The above components of the vehicle control system 2 are connected to each other so that signals can be transmitted therebetween via communication means such as a Controller Area Network (CAN).

The powertrain 4 is a device configured to apply a driving force to the vehicle. The powertrain 4 includes a power source and a transmission, for example. The power source includes at least one of an internal combustion engine, such as a gasoline engine and a diesel engine, and an electric motor. In the present embodiment, the powertrain 4 includes an automatic transmission 16 and a shift actuator 17 for changing a shift position of the automatic transmission 16 (a shift position of the vehicle). The brake device 5 is a device configured to apply a brake force to the vehicle. For example, the brake device 5 includes a brake caliper configured to press a brake pad against a brake rotor and an electric cylinder configured to supply an oil pressure to the brake caliper. The brake device 5 may include an electric parking brake device 5a configured to restrict rotations of wheels via wire cables. The steering device 6 is a device for changing a steering angle of the wheels. For example, the steering device 6 includes a rack-and-pinion mechanism configured to steer (turn) the wheels and an electric motor configured to drive the rack-and-pinion mechanism. The powertrain 4, the brake device 5, and the steering device 6 are controlled by the control device 15.

The external environment sensor 7 serves as an external environment information acquisition device for detecting electromagnetic waves, sound waves, and the like from the surroundings of the vehicle to detect an object outside the vehicle and to acquire surrounding information of the vehicle. The external environment sensor 7 includes sonars 18 and external cameras 19. The external environment sensor 7 may further include a millimeter wave radar and/or a laser lidar. The external environment sensor 7 outputs a detection result to the control device 15.

Each sonar 18 consists of a so-called ultrasonic sensor. Each sonar 18 emits ultrasonic waves to the surroundings of the vehicle and captures the ultrasonic waves reflected by an object around the vehicle thereby to detect a position (distance and direction) of the object. Multiple sonars 18 are provided at each of a rear part and a front part of the vehicle. In the present embodiment, two pairs of sonars 18 are provided on a rear bumper so as to be spaced laterally from each other, two pairs of sonars 18 are provided on a front bumper so as to be spaced laterally from each other, one pair of sonars 18 is provided at a front end portion of the vehicle such that the two sonars 18 forming the pair are provided on left and right side faces of the front end portion of the vehicle, and one pair of sonars 18 is provided at a rear end portion of the vehicle such that the two sonars 18 forming the pair are provided on left and right side faces of the rear end portion of the vehicle. That is, the vehicle is provided with six pairs of sonars 18 in total. The sonars 18 provided on the rear bumper mainly detect positions of objects behind the vehicle. The sonars 18 provided on the front bumper mainly detect positions of objects in front of the vehicle. The sonars 18 provided at the left and right side faces of the front end portion of the vehicle detect positions of objects on left and right outsides of the front end portion of the vehicle, respectively. The sonars 18 provided at the left and right side faces of the rear end portion of the vehicle detect positions of objects on left and right outsides of the rear end portion of the vehicle, respectively.

The external cameras 19 are devices configured to capture images around the vehicle. Each external camera 19 consists of a digital camera using a solid imaging element such as a CCD or a CMOS, for example. The external cameras 19 include a front camera for capturing an image in front of the vehicle and a rear camera for capturing an image to the rear of the vehicle. The external cameras 19 may include a pair of left and right side cameras that are provided in the vicinity of the door mirrors of the vehicle to capture images on left and right sides of the vehicle.

The vehicle sensor 8 includes a vehicle speed sensor configured to detect the speed of the vehicle, an acceleration sensor configured to detect the acceleration of the vehicle, a yaw rate sensor configured to detect the angular velocity around a vertical axis of the vehicle, and a direction sensor configured to detect the direction of the vehicle. For example, the yaw rate sensor consists of a gyro sensor.

The navigation device 10 is a device configured to obtain a current position of the vehicle and provides route guidance to a destination and the like. The navigation device 10 includes a GPS receiving unit 20 and a map storage unit 21. The GPS receiving unit 20 identifies a position (latitude and longitude) of the vehicle based on a signal received from an artificial satellite (positioning satellite). The map storage unit 21 consists of a known storage device such as a flash memory or a hard disk, and stores map information.

The operation input member 11 is provided in a vehicle cabin to receive an input operation performed by the occupant (user) to control the vehicle. The operation input member 11 includes a steering wheel 22, an accelerator pedal 23, a brake pedal 24 (brake input member), and a shift lever 25 (shift member). The shift lever 25 is configured to receive an operation for switching the shift position of the vehicle.

The driving operation sensor 12 detects an operation amount of the operation input member 11. The driving operation sensor 12 includes a steering angle sensor 26 configured to detect a steering angle of the steering wheel 22, a brake sensor 27 configured to detect a pressing amount of the brake pedal 24, and an accelerator sensor 28 configured to detect a pressing amount of the accelerator pedal 23. The driving operation sensor 12 outputs a detected operation amount to the control device 15.

The state detecting sensor 13 is a sensor configured to detect a change in a state of the vehicle according to an operation by the occupant. The operation by the occupant detected by the state detecting sensor 13 includes an operation indicating an alighting intention (intention to alight from the vehicle) of the occupant and an operation indicating absence of an intention of the occupant to check the surroundings of the vehicle during an autonomous parking operation or an autonomous unparking operation. The state detecting sensor 13 includes, as sensors for detecting the operation indicating the alighting intention, a door open/close sensor 29 configured to detect opening and/or closing of a door of the vehicle and a seat belt sensor 30 configured to detect a fastening state of a seat belt. The state detecting sensor 13 includes, as a sensor to detect the operation corresponding to the abdicating intention, a door mirror position sensor 31 configured to detect a position of a door mirror. The state detecting sensor 13 outputs a signal indicating a detected change in the state of the vehicle to the control device 15.

The HMI 14 is an input/output device for receiving an input operation by the occupant and notifying the occupant of various kinds of information by display and/or voice. The HMI 14 includes, for example, a touch panel 32 that includes a display screen such as a liquid crystal display or an organic EL display and is configured to receive the input operation by the occupant, a sound generating device 33 such as a buzzer or a speaker, a parking main switch 34, and a selection input member 35. The parking main switch 34 receives the input operation by the occupant to execute selected one of an automatic parking process (autonomous parking operation) and an automatic unparking process (autonomous unparking operation). The parking main switch 34 is a so-called momentary switch that is turned on only while a pressing operation (pushing operation) is performed by the occupant. The selection input member 35 receives a selection operation by the occupant related to selection of the automatic parking process and the automatic unparking process. The selection input member 35 may consist of a rotary select switch, which preferably requires pressing as the selection operation.

The control device 15 consists of an electronic control unit (ECU) that includes a CPU, a nonvolatile memory such as a ROM, a volatile memory such as a RAM, and the like. The CPU executes operation processing according to a program so that the control device 15 executes various types of vehicle control. The control device 15 may consist of one piece of hardware, or may consist of a unit including multiple pieces of hardware. Further, the functions of the control device 15 may be at least partially executed by hardware such as an LSI, an ASIC, and an FPGA, or may be executed by a combination of software and hardware.

Further, the control device 15 executes an arithmetic process according to a program and thereby performs a conversion process of an image (video) captured by the external cameras 19 so as to generate a look-down image corresponding to a plan view of the vehicle and its surrounding area and a bird's-eye image corresponding to a three-dimensional image of the vehicle and a part of its surrounding area positioned in the travel direction as viewed from above. The control device 15 may generate the look-down image by combining the images of the front camera, the rear camera, and the left and right side cameras, and may generate the bird's-eye image by combining the image captured by the front camera or the rear camera facing the travel direction and the images captured by the left and right side cameras.

The parking assist system 1 is a system for executing the so-called automatic parking process and the so-called automatic unparking process, in which a vehicle is moved autonomously to a prescribed target position (a target parking position or a target unparking position) selected by the occupant so as to park or unpark the vehicle.

The parking assist system 1 includes the control device 15, the brake pedal 24 as a brake input member, the driving operation sensor 12, and the state detecting sensor 13.

The control device 15 controls the powertrain 4, the brake device 5, and the steering device 6 so as to execute an autonomous parking operation to move the vehicle autonomously to a target parking position and park the vehicle at the target parking position and an autonomous unparking operation to move the vehicle autonomously to a target unparking position and unpark the vehicle at the target unparking position. In order to execute such operations, the control device 15 includes an external environment recognizing unit 41, a vehicle position identifying unit 42, an action plan unit 43, a travel control unit 44, a vehicle abnormality detecting unit 45, and a vehicle state determining unit 46.

The external environment recognizing unit 41 recognizes an obstacle (for example, a parked vehicle or a wall) that is present around the vehicle based on the detection result of the external environment sensor 7, and thereby obtains information about the obstacle. Further, the external environment recognizing unit 41 analyzes the images captured by the external cameras 19 based on a known image analysis method such as pattern matching, and thereby determines whether a wheel stopper or an obstacle is present, and obtains the size of the wheel stopper or the obstacle in a case where the wheel stopper or the obstacle is present. Further, the external environment recognizing unit 41 may compute a distance to the obstacle based on signals from the sonars 18 to obtain the position of the obstacle.

Also, by the analysis of the detection result of the external environment sensor 7 (more specifically, by the analysis of the images captured by the external cameras 19 based on a known image analysis method such as pattern matching), the external environment recognizing unit 41 can acquire, for example, a lane on a road delimited by road signs and a parking space delimited by white lines and the like provided on a surface of a road, a parking lot, and the like.

The vehicle position identifying unit 42 identifies the position of the vehicle (the own vehicle) based on a signal from the GPS receiving unit 20 of the navigation device 10. Further, the vehicle position identifying unit 42 may obtain the vehicle speed and the yaw rate from the vehicle sensor 8, in addition to the signal from the GPS receiving unit 20, and identify the position and posture of the vehicle by the so-called inertial navigation.

The travel control unit 44 controls the powertrain 4, the brake device 5, and the steering device 6 based on a travel control instruction from the action plan unit 43 to make the vehicle travel.

The vehicle abnormality detecting unit 45 detects an abnormality of the vehicle (hereinafter referred to as “vehicle abnormality”) based on signals from various devices and sensors. The vehicle abnormality detected by the vehicle abnormality detecting unit 45 includes failure of various devices necessary for driving the vehicle (for example, the powertrain 4, the brake device 5, and the steering device 6) and failure of various sensors necessary for making the vehicle travel autonomously (for example, the external environment sensor 7, the vehicle sensor 8, and the GPS receiving unit 20). Further, the vehicle abnormality includes failure of the HMI 14.

In the present embodiment, the vehicle abnormality detecting unit 45 can detect an abnormality in the screen display of the touch panel 32 based on at least a signal from the touch panel 32.

The vehicle state determining unit 46 acquires the state of the vehicle based on signals from various sensors provided in the vehicle, and determines whether the vehicle is in a prohibition state in which the autonomous movement (namely, the autonomous parking operation or the autonomous unparking operation) of the vehicle should be prohibited. The vehicle state determining unit 46 determines that the vehicle is in the prohibition state when the occupant performs a driving operation (override operation) of the operation input member 11. The override operation is an operation to override (cancel) the autonomous movement (namely, the autonomous parking operation or the autonomous unparking operation) of the vehicle.

More specifically, the vehicle state determining unit 46 may determine the initiation of the override operation when the pressing amount of the brake pedal 24 acquired (detected) by the brake sensor 27 has reached or exceeded a prescribed threshold (hereinafter referred to as “pressing threshold”). Additionally or alternatively, the vehicle state determining unit 46 may determine the initiation of the override operation when a pressing amount of the accelerator pedal 23 acquired (detected) by the accelerator sensor 28 has reached or exceeded a prescribed threshold. The vehicle state determining unit 46 may also determine the initiation of the override operation when a changing rate of the steering angle obtained (detected) by the steering angle sensor 26 has reached or exceeded a prescribed threshold.

Further, the vehicle state determining unit 46 determines, based on the detection result of the state detecting sensor 13, that the vehicle is in the prohibition state when the vehicle is in a state that reflects the alighting intention (intention to alight from the vehicle) of the occupant. More specifically, when the door open/close sensor 29 detects that the door is opened, the vehicle state determining unit 46 determines that the vehicle is in the prohibition state. Also, when the seat belt sensor 30 detects that the seat belt is released, the vehicle state determining unit 46 determines that the vehicle is in the prohibition state.

Further, the vehicle state determining unit 46 determines that, based on the detection result of the state detecting sensor 13, that the vehicle is in the prohibition state when the vehicle is in a state that reflects the absence of intention of the occupant to check the surroundings of the vehicle. More specifically, the vehicle state determining unit 46 determines that the vehicle is in the prohibition state when the door mirror position sensor 31 detects that the door mirror is retracted.

Also, when it is determined, based on the detection result of the state detecting sensor 13, that the door is opened and the seat belt is released, the vehicle state determining unit 46 determines that the alighting intention of the occupant is certain and that the vehicle is in a cancellation state in which the autonomous movement (namely, the autonomous parking operation or the autonomous unparking operation) of the vehicle should be canceled. In addition, the vehicle state determining unit 46 may determine that the vehicle is in the cancellation state when there is an input to a cancellation button displayed on the touch panel 32 while the vehicle is moving autonomously.

In the present embodiment, each vehicle seat provided in the vehicle cabin is provided with a seating sensor configured to detect seating of the occupant. The vehicle state determining unit 46 determines a seating position of the occupant (namely, the vehicle state determining unit 46 identifies the vehicle seat on which the occupant is seated) based on a signal from the seating sensor, and determines that the vehicle is in the cancellation state when the seat belt at the seating position is released and the door near the seating position is opened.

As described above, the driving operation sensor 12 and the state detecting sensor 13 each correspond to the vehicle state detecting device configured to detect the state of the vehicle (for example, the prohibition state in which the autonomous parking operation or the autonomous unparking operation of the vehicle should be prohibited). The vehicle state determining unit 46 determines the state of the vehicle based on the detection results of the driving operation sensor 12 and the state detecting sensor 13. By using the driving operation sensor 12, it is possible to easily detect the override operation of the occupant. By using the state detecting sensor 13, it is possible to easily detect an alighting operation of the user and a change in the state of the vehicle according to an extending/retracting operation of the door mirror.

The action plan unit 43 executes the automatic parking process (autonomous parking operation) or the automatic unparking process (autonomous unparking operation) when the vehicle is in a prescribed state and the HMI 14 or the parking main switch 34 receives a prescribed input by the user, which corresponds to a request for the automatic parking process or the automatic unparking process. More specifically, the action plan unit 43 executes the automatic parking process in a case where a prescribed input corresponding to the automatic parking process is performed when the vehicle is stopped or the vehicle is traveling at a low speed equal to or less than a prescribed vehicle speed (a vehicle speed at which a parking position candidate can be searched for). The action plan unit 43 executes the automatic unparking process (parallel unparking process) in a case where a prescribed input corresponding to the automatic unparking process is performed when the vehicle is stopped. The selection of the process to be executed (the automatic parking process or the automatic unparking process) may be made by the action plan unit 43 based on the state of the vehicle. Alternatively, the above selection may be made by the occupant via the touch panel 32 or the selection input member 35. When executing the automatic parking process, the action plan unit 43 first makes the touch panel 32 display a parking search screen for setting the target parking position. After the target parking position is set, the action plan unit 43 makes the touch panel 32 display a parking screen. When executing the automatic unparking process, the action plan unit 43 first makes the touch panel 32 display an unparking search screen for setting the target unparking position. After the target unparking position is set, the action plan unit 43 makes the touch panel 32 display an unparking screen.

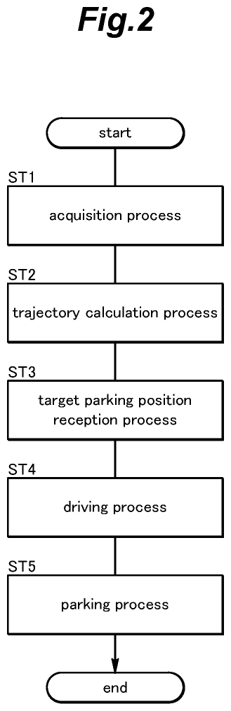

In the following, the automatic parking process will be described with reference to FIG. 2. The action plan unit 43 first executes an acquisition process (step ST1) to acquire one or more parking spaces, if any. More specifically, in a case where the vehicle is stopped, the action plan unit 43 first makes the touch panel 32 of the HMI 14 display a notification that instructs the occupant to move the vehicle straight. While the occupant sitting in the driver's seat (hereinafter referred to as “driver”) is moving the vehicle straight, the external environment recognizing unit 41 acquires, based on a signal from the external environment sensor 7, a position and size of each detected obstacle and positions of the white lines provided on the road surface. The external environment recognizing unit 41 extracts, based on the acquired position and size of the obstacle and the acquired positions of the white lines, one or more undelimited parking spaces and one or more delimited parking spaces, if any (hereinafter, the undelimited parking spaces and the delimited parking spaces will be collectively referred to as “parking spaces”). Each undelimited parking space is a space that is not delimited by the white lines or the like, has a size sufficient to park the vehicle, and is available (namely, there is no obstacle therein). Each delimited parking space is a space that is delimited by the white lines or the like, has a size sufficient to park the vehicle, and is available (namely, another vehicle (vehicle other than the own vehicle) is not parked).

Next, the action plan unit 43 executes a trajectory calculation process (step ST2) to calculate a trajectory of the vehicle from a current position of the vehicle to each extracted parking space. In a case where the trajectory of the vehicle can be calculated for a certain parking space, the action plan unit 43 sets the parking space as a parking position candidate where the vehicle can be parked, and make the touch panel 32 display the parking position candidate on the screen (the parking search screen). In a case where the trajectory of the vehicle cannot be calculated due to the presence of the obstacle, the action plan unit 43 does not set the parking space as a parking position candidate and does not make the touch panel 32 display the parking space on the screen. When the action plan unit 43 sets multiple parking position candidates (namely, multiple parking places for which the trajectory of the vehicle can be calculated), the action plan unit 43 makes the touch panel 32 display these parking position candidates.

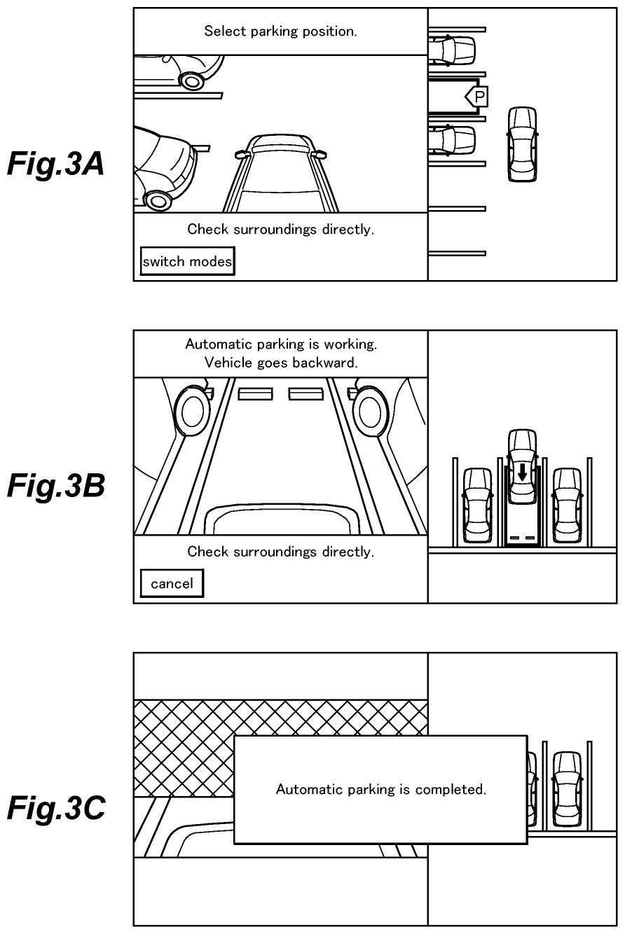

Next, the action plan unit 43 executes a target parking position reception process (step ST3) to receive a selection operation performed by the occupant to select the target parking position, which is a parking position where the occupant wants to park the vehicle, and is selected from the one or more parking position candidates displayed on the touch panel 32. More specifically, the action plan unit 43 makes the touch panel 32 display the look-down image and the bird's-eye image in the travel direction on the parking search screen shown in FIG. 3A. When the action plan unit 43 acquires at least one parking position candidate, the action plan unit 43 makes the touch panel 32 display a frame that indicates the parking position candidate and an icon that corresponds to the frame in at least one of the look-down image and the bird's-eye image (in the look-down image in FIG. 3A) in an overlapping manner. The icon consists of a symbol indicating the parking position candidate (see “P” in FIG. 3A). Also, the action plan unit 43 makes the touch panel 32 display the parking search screen including a notification that instructs the driver to stop the vehicle and select the target parking position, so that the touch panel 32 receives the selection operation of the target parking position. The selection operation of the target parking position may be performed via the touch panel 32, or may be performed via the selection input member 35.

After the vehicle is stopped and the target parking position is selected by the driver, the action plan unit 43 makes the touch panel 32 switch the screen from the parking search screen to the parking screen. As shown in FIG. 3B, the parking screen is a screen in which an image in the travel direction of the vehicle (hereinafter referred to as “travel direction image”) is displayed on the left half of the touch panel 32 and the look-down image including the vehicle and its surrounding area is displayed on the right half thereof. At this time, the action plan unit 43 may make the touch panel 32 display a thick frame that indicates the target parking position selected from the parking position candidates and an icon that corresponds to the thick frame such that the thick frame and the icon overlap with the look-down image. This icon consists of a symbol indicating the target parking position, and is shown in a color different from the symbol indicating the parking position candidate.

After the target parking position is selected and the screen of the touch panel 32 is switched to the parking screen, the action plan unit 43 executes a driving process (step ST4) to make the vehicle travel along the calculated trajectory. At this time, the action plan unit 43 controls the vehicle based on the position of the vehicle acquired by the GPS receiving unit 20 and the signals from the external cameras 19, the vehicle sensor 8, and the like so that the vehicle travels along the calculated trajectory. At this time, the action plan unit 43 controls the powertrain 4, the brake device 5, and the steering device 6 so as to execute a switching operation for switching the travel direction of the vehicle (a reversing operation for reversing the travel direction of the vehicle). The switching operation may be executed repeatedly, or may be executed only once.

During the driving process, the action plan unit 43 may acquire the travel direction image from the external cameras 19 and make the touch panel 32 display the acquired travel direction image on the left half thereof. For example, as shown in FIG. 3B, when the vehicle is moving backward, the action plan unit 43 may make the touch panel 32 display an image to the rear of the vehicle captured by the external cameras 19 on the left half thereof. While the action plan unit 43 is executing the driving process, the surrounding image of the vehicle (the own vehicle) in the look-down image displayed on the right half of the touch panel 32 changes along with the movement of the vehicle. When the vehicle reaches the target parking position, the action plan unit 43 stops the vehicle and ends the driving process.

When the driving process ends, the action plan unit 43 executes a parking process (step ST5). In the parking process, the action plan unit 43 first drives the shift actuator 17 to set the shift position (shift range) to a parking position (parking range). Thereafter, the action plan unit 43 drives the parking brake device 5a, and makes the touch panel 32 display a pop-up window (see FIG. 3C) indicating that the automatic parking of the vehicle has been completed. The pop-up window may be displayed on the screen of the touch panel 32 for a prescribed period. Thereafter, the action plan unit 43 may make the touch panel 32 switch the screen to an operation screen of the navigation device 10 or a map screen.

In the parking process, there may be a case where the shift position cannot be changed to the parking position because of an abnormality of the shift actuator 17 or a case where the parking brake device 5a cannot be driven because of an abnormality of the parking brake device 5a. In these cases, the action plan unit 43 may make the touch panel 32 display the cause of the abnormality on the screen thereof.

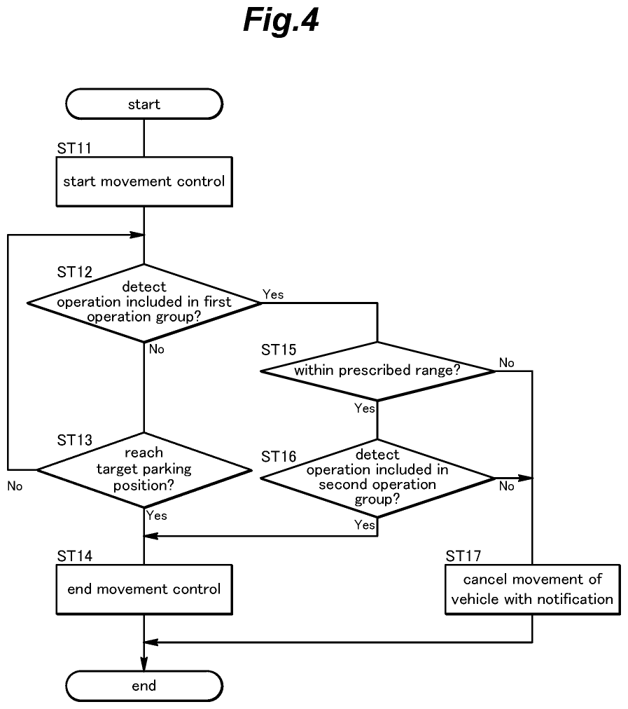

Next, with reference to FIG. 1 and FIG. 4, the details of the automatic parking process (more specifically, the details of the driving process (step ST4) and the parking process (step ST5) of FIG. 2) will be described with regard to a case where control of the vehicle to the target position (hereinafter referred to as “movement control”) ends (is canceled) according to a driver's operation or the like. In the following, the automatic parking process to move the vehicle from the current position to the target parking position will be described as an example. However, the present invention can be applied to the automatic unparking process to move the vehicle from the current position to the target unparking position in the vicinity thereof.

After the automatic parking process is started, the action plan unit 43 calculates a trajectory (movement route) from the current position to the target parking position (see step ST2 in FIG. 2). Subsequently, the travel control unit 44 starts to move the vehicle autonomously along the calculated trajectory. Namely, the control device 15 starts the movement control (step ST11).

Next, the control device 15 checks whether a prescribed operation input member 11 is operated by the driver while moving the vehicle autonomously. More specifically, the control device 15 determines whether an operation by the driver included in a first operation group is detected during the movement control (step ST12). In a case where the control device 15 determines that the operation included in the first operation group is not detected (No in step ST12), the control device 15 determines whether the vehicle has reached the target parking position (step ST13). In a case where the control device 15 determines that the vehicle has not reached the target parking position (No in step ST13), the control device 15 executes step ST12 again. In a case where the control device 15 determines that the vehicle has reached the target parking position (Yes in step ST13), the control device 15 ends the movement control (step ST14). When ending the movement control right after step ST13 as described above, the control device 15 stops the vehicle, makes the output device such as the touch panel 32 and/or the sound generating device 33 notify the driver that the movement control (automatic parking process) ends, makes the shift actuator 17 switch the shift position to the parking position, and drives the parking brake device 5a. A vehicle position detecting device, which includes the external environment sensor 7, the navigation device 10, and/or an odometer, detects the position of the vehicle with respect to the target parking position. The control device 15 identifies the position of the vehicle with respect to the trajectory including the target parking position based on the information from the vehicle position detecting device.

As described above, in step ST12, the control device 15 determines whether the operation by the driver included in the first operation group is detected. The control device 15 sets the first operation group such that the first operation group includes the operation of the steering wheel 22 (the operation for driving the steering device 6), the operation of the accelerator pedal 23 (the operation for driving the powertrain 4), the operation of the brake pedal 24 (the operation for driving the brake device 5), the operation of the shift lever 25 for switching the shift position to a parking position, the operation of a parking brake lever 51 as a parking brake input member (the operation for driving the parking brake device 5a), the operation of the parking main switch 34 (the operation for switching a control state of an autonomous movement of the vehicle), and the operation of releasing the seat belt and opening the door (the operation by the occupant related to alighting from the vehicle). The operation included in the first operation group is detected by a first operation detecting device. The first operation detecting device includes the steering angle sensor 26 that detects the operation of the steering wheel 22, the accelerator sensor 28 that detects the operation of the accelerator pedal 23, the brake sensor 27 that detects the operation of the brake pedal 24, a shift lever sensor 52 that detects the operation of the shift lever 25, a parking brake lever sensor 53 that detects the operation of the parking brake lever 51, the parking main switch 34 that detects the operation for switching the control state of the autonomous movement of the vehicle, and the door open/close sensor 29 and the seat belt sensor 30 that detect the operation by the occupant related to alighting from the vehicle.

In a case where the control device 15 determines that the operation included in the first operation group is detected (Yes in step ST12), the control device 15 then determines whether the position of the vehicle is within a prescribed range from the target parking position (step ST15). In a case where the control device 15 determines that the position of the vehicle is within the prescribed range from the target parking position (Yes in step ST15), the control device determines whether an operation included in a second operation group and related to a stop of the vehicle is detected (namely, whether the operation detected in step ST12 is included in the second operation group) (step ST16). The control device 15 sets the second operation group such that the second operation group includes the operation of the brake pedal 24, the operation of the parking brake lever 51, and the operation of the shift lever 25 for switching the shift position to the parking position. The control device 15 sets the second operation group such that the second operation group does not include the operation of the steering wheel 22, the operation of the parking main switch 34, and the operation of releasing the seat belt and opening the door. The control device 15 sets the first operation group and the second operation group such that the first operation group includes the operation included in the second operation group. The operation included in the second operation group is detected by a second operation detecting device. The second operation detecting device includes the brake sensor 27 that detects the operation of the brake pedal 24, the shift lever sensor 52 that detects the operation of the shift lever 25, and the parking brake lever sensor 53 that detects the operation of the parking brake lever 51. Since the second operation group is included in the first operation group, the second operation detecting device is included in the first operation detecting device. Namely, since the second operation group is a subset of the first operation group, the second operation detecting device is a subset of the first operation detecting device. The control device 15 may set the prescribed range (see step ST15) based on the form of parking (parallel parking, perpendicular parking, and the like) and the surrounding conditions (distance to other parked vehicles or roads), and the like.

In a case where the control device 15 determines that the position of the vehicle is not within the prescribed range from the target parking position (No in step ST15), or in a case where the control device 15 determines that the operation included in the second operation group is not detected (No in step ST16), the control device 15 makes the output device such as the touch panel 32 and/or the sound generating device 33 notify the driver that the movement control is canceled, stops the vehicle, and cancels the movement of the vehicle to the target position so as to end the movement control (step ST17). For example, the sound generating device 33 may notify the driver that the movement control is canceled by generating a warning sound or a voice indicating that the vehicle is stopped because the operation input member 11 has been operated. Additionally or alternatively, the touch panel 32 may notify the driver that the movement control is canceled by displaying a message and/or a figure indicating that the vehicle is stopped because the operation input member 11 has been operated.

In a case where the driver operates the steering wheel 22 or the accelerator pedal 23 during the movement control, it can be estimated that the driver intends to shift to a manual driving state. In light of such a driver's intention, in a case where the operation of the steering wheel 22 or the accelerator pedal 23 is detected during the movement control, the control device 15 may set the vehicle to the manual driving state in which the vehicle is moved according to driving by the driver, after stopping the vehicle and ending the movement control. By setting the vehicle to the manual driving state as described above, the driver can drive the vehicle without performing the operation for selecting the control state of the autonomous movement of the vehicle (manual driving state or automatic driving state) after the end of the movement control by the control device 15, so that the convenience of the driver can be improved. In a case where the driver operates the parking main switch 34 for switching the control state of the autonomous movement of the vehicle, it can be estimated that the driver intends to end the movement control (automatic parking assistance) and that the driver does not think that the vehicle has reached the target parking position. In light of such a driver's intention, when the driver operates the parking main switch 34, the control device 15 ends the movement control (automatic parking assistance) without estimating that the driver thinks that the vehicle has reached the target parking position. Accordingly, it is possible to control the movement of the vehicle according to the driver's intention, so that the convenience of the driver can be improved. Also, in a case where the occupant releases the seat belt and opens the door (namely, in a case where the occupant tries to alight from the vehicle) during the movement control, the vehicle is stopped and the notification that the movement control is canceled is made, so that the safety of the occupant and the convenience of the driver are improved.

Incidentally, when the steering angle is changed due to the unevenness of the road surface and thereby the steering angle sensor 26 detects the change in the steering angle, the control device 15 may erroneously determine that the steering wheel 22 is operated. Even in such a case, the driver can execute the automatic parking process again from the trajectory calculation process (see ST2 of FIG. 2) by operating the touch panel 32, the parking main switch 34, and/or the selection input member 35.

In a case where the driver operates the brake pedal 24 (namely, in a case where the driver performs the operation for driving the brake device 5) when the position of the vehicle is not within the prescribed range from the target parking position, it can be estimated that the driver finds an obstacle in the travel direction of the vehicle or its vicinity and then operates the brake pedal 24. In such a case, after stopping the vehicle and ending the movement control, the control device 15 may make the touch panel 32 display a selection screen for selecting the resumption of the automatic parking process (automatic parking process to a calculated target parking position along a calculated trajectory), the retrial of the automatic parking process (automatic parking process to a new target parking position along a new trajectory), or the start of the manual driving state so that the driver can select the next executable process according to the movement of the obstacle.

In a case where the position of the vehicle is within the prescribed range from the target parking position (Yes in step ST15) and the operation included in the second operation group is detected (Yes in step ST16), it can be estimated that the driver thinks that the vehicle has reached the target parking position and thereby performs the operation included in the second operation (for example, the operation of the brake pedal 24). In light of such a driver's intention, the control device 15 stops the vehicle and ends the movement control without making the output device such as the touch panel 32 and/or the sound generating device 33 notify that the movement control is canceled (step ST14). That is, in such a case, the control device 15 ends the movement control (automatic parking process) by the same process as in a case where the vehicle has reached the target parking position and thereby the movement control normally ends. Thereby, the driver is not bothered by a warning sound by the sound generating device 33, an operation for selecting a process after the vehicle is stopped, and the like, so that the convenience of the driver can be improved.

Concrete embodiments of the present invention have been described in the foregoing, but the present invention should not be limited by the foregoing embodiments and various modifications and alterations are possible within the scope of the present invention. In other embodiments, the second operation group may not be included in the first operation group (namely, the second operation group may not be a subset of the first operation group). When the second operation group is not included in the first operation group, in step ST12, the control device 15 may determine whether the operation by the driver included in the first operation group or the second operation group is detected.

1. A parking assist system, comprising:
a control device configured to control a vehicle including a powertrain, a brake device, and a steering device so as to move the vehicle autonomously from a current position to a target position;
a vehicle position detecting device configured to detect a position of the vehicle with respect to the target position;
a first operation detecting device configured to detect an operation by a driver included in a first operation group;
a second operation detecting device configured to detect an operation by the driver included in a second operation group and related to a stop of the vehicle; and
an output device configured to make a notification to an occupant based on an instruction from the control device,
wherein during control of the vehicle to the target position,
when the first operation detecting device detects any of the operation by the driver included in the first operation group, the control device makes the output device notify that the control of the vehicle to the target position is canceled, stops the vehicle, and cancels a movement of the vehicle to the target position, and
when the position of the vehicle detected by the vehicle position detecting device is within a prescribed range from the target position and the second operation detecting device detects any of the operation by the driver included in the second operation group, the control device stops the vehicle and ends the control of the vehicle to the target position without making the output device notify that the control of the vehicle to the target position is canceled.

2. The parking assist system according to claim 1, wherein the first operation group includes the operation included in the second operation group.

3. The parking assist system according to claim 2, wherein the vehicle further includes:
a brake input member configured to receive an operation for driving the brake device;
a parking brake input member configured to receive an operation for driving a parking brake device; and
a shift member configured to receive an operation for switching a shift position, and
the second operation group includes the operation of the brake input member, the operation of the parking brake input member, and the operation of the shift member for switching the shift position to a parking position.

4. The parking assist system according to claim 2, wherein the vehicle further includes a switch for switching a control state of an autonomous movement of the vehicle, and
the first operation group includes an operation for driving the steering device or the brake device, the operation of the switch, and an operation by the occupant related to alighting from the vehicle.

5. The parking assist system according to claim 4, wherein the second operation group does not include the operation for driving the steering device, the operation of the switch, and the operation by the occupant related to alighting from the vehicle.

6. The parking assist system according to claim 4, wherein the second operation group includes the operation for driving the brake device.

7. The parking assist system according to claim 4, wherein during the control of the vehicle to the target position, in a case where the operation for driving the steering device is detected and thereby the movement of the vehicle to the target position is canceled, the control device sets the vehicle to a state in which the vehicle is moved according to driving by the driver.

8. The parking assist system according to claim 1, wherein during the control of the vehicle to the target position,
when the first operation detecting device detects any of the operation by the driver included in the first operation group, on condition that the position of the vehicle detected by the vehicle position detecting device is not within the prescribed range from the target position or the second operation detecting device does not detect any of the operation by the driver included in the second operation group, the control device makes the output device notify that the control of the vehicle to the target position is canceled, stops the vehicle, and cancels the movement of the vehicle to the target position.
